(19) United States
(12) Patent Application Publication
(10) Pub. No.: US 2025/0354613 A1
(43) Pub. Date: Nov. 20, 2025

(54) FLUID CONTROL VALVE AND FLUID CONTROL DEVICE

(71) Applicant: HORIBA STEC, Co., Ltd., Kyoto-shi (JP)

(72) Inventors: Kazuya SHAKUDO, Irvine, CA (US); Yuki HIDA, Irvine, CA (US)

(21) Appl. No.: 19/212,430

(22) Filed: May 19, 2025

(30) Foreign Application Priority Data
May 20, 2024 (JP) 2024-081515

(51) Int. Cl. F16K 1/42; F16K 1/36

(52) U.S. Cl. CPC F16K 1/42; F16K 1/36

(57) ABSTRACT

The present invention reduces seat leakage while increasing a flow rate, and includes an orifice 31 having a valve seat surface 31s and a valve body 32 having a seating surface 32s seated on the valve seat surface 31s. The orifice 31 has an annular groove M1 formed in the valve seat surface 31s and an internal flow path L1 communicating with an upstream flow path R1 and opened in the annular groove M1. The internal flow path L1 is opened on the same plane as the valve seat surface 31s and extends outward of the annular groove M1 in plan view.

### BACKGROUND OF THE INVENTION

### Technical Field

The present invention relates to a fluid control valve and a fluid control device.

### Description of the Related Art

As conventional fluid control valves, as illustrated in JP 2010-230159 A and JP 5735331 B2, fluid control valves are considered in which a plurality of recessed grooves is formed on a valve seat surface of an orifice, and an internal flow path is opened to a bottom surface or a side surface of the recessed groove. Specifically, a recessed groove in which an inflow port is formed and a recessed groove in which an outflow port is formed are different from each other, and the valve seat surface is formed between the recessed grooves.

### PRIOR ART DOCUMENT

### Patent Documents

Patent Document 1: JP 2010-230159 A
Patent Literature 2: JP 5735331 B2

### SUMMARY OF THE INVENTION

In both of the fluid control valves described above, the internal flow path is opened to the bottom surface or the side surface of the recessed groove, and in order to increase the flow rate, it is conceivable to increase a width of the recessed groove to increase diameters of openings of the inflow port and the outflow port. However, if the width of each recessed groove is increased, the width of the valve seat surface formed between the recessed grooves is decreased, and there is a possibility that a seat leakage amount in a fully closed state increases.

On the other hand, in order to reduce the seat leakage amount in the fully closed state in the fluid control valve, it is conceivable to increase the width of the valve seat surface formed between the recessed grooves. However, if the width of the valve seat surface is increased, the width of each recessed groove is reduced, the diameters of the openings of the inflow port and the outflow port formed on the bottom surface of the recessed groove are reduced, and there is a possibility that an increase in the flow rate is prevented. In JP 2010-230159 A and JP 5735331 B2, the seat leakage amount is not considered at all.

Therefore, the present invention has been made in view of the above-described problems, and a main object of the invention is to reduce seat leakage while increasing a flow rate.

A fluid control valve of the present invention controls a fluid from an upstream flow path to flow out to a downstream flow path, the fluid control valve including an orifice having a valve seat surface, and a valve body having a seating surface seated on the valve seat surface, in which the orifice includes an annular groove formed in the valve seat surface, and an internal flow path communicating with the upstream flow path or the downstream flow path and communicating with the annular groove, the internal flow path is opened on a same plane as the valve seat surface, and an opening of the internal flow path extends outward of the annular groove in plan view.

In the fluid control valve as described above, the internal flow path is opened on the same plane as the valve seat surface, and the opening extends outward of the annular groove in plan view. It is therefore possible to reduce seat leakage while improving the maximum flow rate. Specifically, in the configuration in which the internal flow path is opened to the bottom surface or the side surface of the annular groove as in JP 2010-230159 A and JP 5735331 B2, the size of the opening in the valve seat surface is limited to the groove width of the annular groove, but in the present invention, the size of the opening of the internal flow path in the valve seat surface is not limited to the groove width of the annular groove. As a result, the maximum flow rate can be improved. The groove width of the annular groove can be narrowed regardless of the size of the opening of the internal flow path. As a result, the area of the valve seat surface can be increased, and seat leakage can be reduced. Furthermore, by increasing the area of the valve seat surface, a stress generated between the valve seat surface and the seating surface in the fully closed state can be reduced, and damage of the seating surface or the valve seat surface can be reduced.

As a specific embodiment of the internal flow path and the annular groove, it is conceivable that the internal flow path includes an upstream internal flow path communicating with the upstream flow path and a downstream internal flow path communicating with the downstream flow path, and the annular groove includes an upstream annular groove communicating with the upstream internal flow path and a downstream annular groove communicating with the downstream internal flow path.

In this configuration, the upstream internal flow path is desirably opened on the same plane as the valve seat surface, and an opening of the upstream internal flow path desirably extends outward of the upstream annular groove in plan view.

The downstream internal flow path is desirably opened on the same plane as the valve seat surface, and an opening of the downstream internal flow path desirably extends outward of the downstream annular groove in plan view.

As a specific embodiment of the annular grooves, the upstream annular groove and the downstream annular groove are desirably formed substantially concentrically in the valve seat surface.

In this configuration, the fluid flowing out from the upstream annular groove flows into the adjacent downstream annular grooves evenly in a circumferential direction, and a pressure loss can be reduced to increase the flow rate.

The upstream annular groove and the downstream annular groove are desirably formed alternately in the valve seat surface.

In this configuration, a distance between the opening (inflow port) of the upstream internal flow path and the opening (outflow port) of the downstream internal flow path can be shortened as much as possible, and the pressure loss can be reduced to increase the flow rate.

As a specific embodiment for increasing the flow rate, a plurality of the upstream internal flow paths desirably communicates with the upstream annular groove, and a plurality of the downstream internal flow paths desirably communicates with the downstream annular groove.

In order to facilitate manufacturing of the fluid control valve and effectively utilize the area of the valve seat surface, the openings of the upstream internal flow paths and the openings of the downstream internal flow paths are desirably formed to be shifted from each other in the circumferential direction in the plan view.

The upstream annular groove and the downstream annular groove desirably have different depths from each other.

In this configuration, the upstream internal flow path and the downstream internal flow path can be formed inside the orifice without any difficulty so as not to interfere with each other.

As a specific embodiment of the orifice, an internal flow path penetrating from a lower surface opposite to the valve seat surface desirably communicates with a shallower annular groove of the upstream annular groove or the downstream annular groove. For example, in a case where the upstream annular groove is shallower than the downstream annular groove, the upstream internal flow path penetrates from the lower surface opposite to the valve seat surface.

As a specific embodiment of the orifice, a linear internal flow path penetrating from a side surface other than the valve seat surface and the lower surface opposite to the valve seat surface desirably communicates with a deeper annular groove of the upstream annular groove or the downstream annular groove. For example, in a case where the downstream annular groove is deeper than the upstream annular groove, the downstream internal flow path is a linear flow path formed from a side surface other than the valve seat surface and the lower surface.

A fluid control device including the fluid control valve described above is also an aspect of the present invention. This fluid control device specifically includes the fluid control valve described above, a flow rate measurement unit that measures a flow rate of a flow path, and a valve controller that controls the fluid control valve on a basis of a measurement value measured by the flow rate measurement unit.

The present invention described above can reduce seat leakage while increasing the flow rate.

### BRIEF DESCRIPTION OF THE DRAWINGS

FIG. 1 is a schematic diagram illustrating a configuration of a fluid control device according to an embodiment of the present invention;

FIG. 2 is an enlarged sectional view illustrating a configuration of a fluid control valve according to the embodiment;

FIG. 3 is a perspective view of an orifice according to the embodiment;

FIG. 4 is a plan view of the orifice according to the embodiment;

FIG. 5 is a sectional view taken along line A-A in the same embodiment;

FIG. 6 is a sectional view taken along line B-B in the same embodiment;

FIG. 7(a) is a plan view in which an opening of an upstream internal flow path and an upstream annular groove according to the embodiment are hatched;

FIG. 7(b) is a plan view in which an opening of a downstream internal flow path and a downstream annular groove are hatched;

FIG. 8 is a graph illustrating a comparison result between the present example and a conventional example of a maximum flow rate for flowing in a fully opened state; and

FIG. 9 is a graph illustrating a comparison result of the present example and the conventional example of a seat leakage amount in the fully closed state.

### DETAILED DESCRIPTION

Hereinafter, a fluid control device according to an embodiment of the present invention will be described with reference to the drawings. Note that any of the drawings described below is omitted appropriately or depicted in a schematic and exaggerated manner for easy understanding. The same components are denoted by the same reference signs, and the description thereof will be omitted as appropriate.

### <Configuration of Device>

A fluid control device 100 according to the present embodiment is a so-called mass flow controller, and is used, for example, to control a flow rate of gas supplied to a chamber in which a semiconductor manufacturing process is performed. Note that the fluid control device 100 may control not only gas but also liquid.

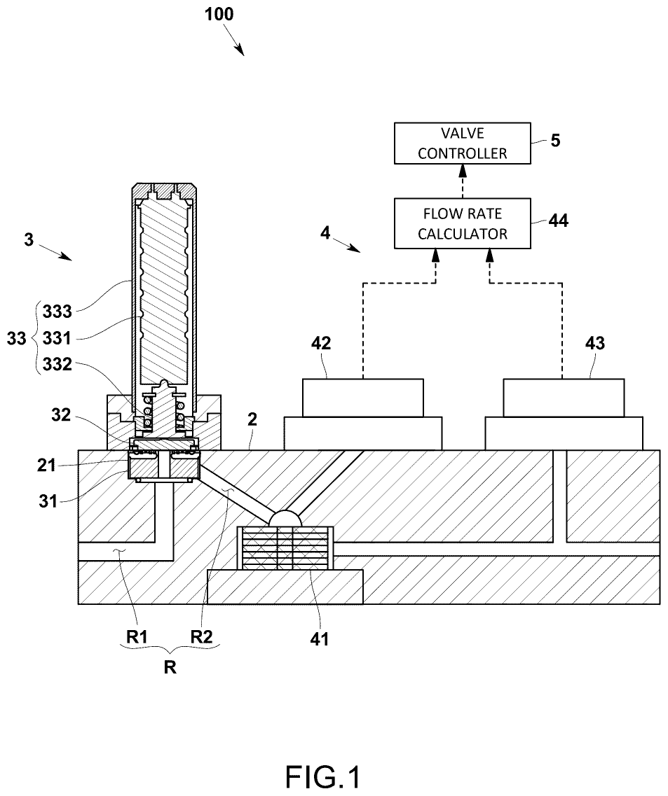

Specifically, as illustrated in FIG. 1, the fluid control device 100 includes a flow path block 2 in which a flow path R is formed, a fluid control valve 3 for controlling gas in the flow path R, a flow rate sensor 4 that measures a flow rate of the flow path R, and a valve controller 5 that controls the fluid control valve 3 on the basis of a measurement value measured by the flow rate sensor 4.

The flow path block 2 is provided with a housing recess 21 to which the fluid control valve 3 is attached. The housing recess 21 is formed on one surface (upper surface in FIG. 1) of the flow path block 2. An upstream flow path R1 is connected to a bottom surface of the housing recess 21, and a downstream flow path R2 is connected to an inner peripheral surface of the housing recess 21. That is, the flow path R formed in the flow path block 2 is divided into the upstream flow path R1 and the downstream flow path R2 by the housing recess 21.

A gas introduction port (not illustrated) is provided at an upstream end of the upstream flow path R1, and a gas lead-out port (not illustrated) is provided at a downstream end of the downstream flow path R2.

The fluid control valve 3 is a so-called normally open piezo valve, and has an opening degree controlled by an applied voltage. Note that the fluid control valve 3 may be a so-called normally closed valve.

Specifically, as illustrated in FIG. 1, the fluid control valve 3 includes an orifice (valve seat member) 31 having a valve seat surface 31s, a valve body 32 having a seating surface 32s seated on the valve seat surface 31s, and a drive unit 33 that drives the valve body 32.

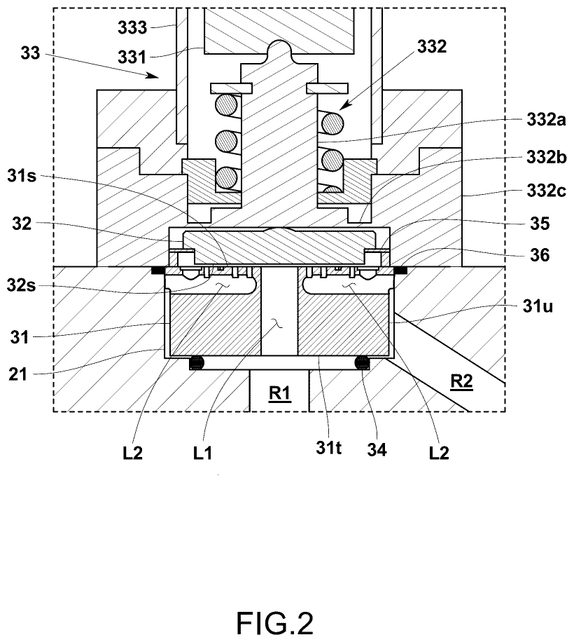

As illustrated in FIG. 2, the orifice 31 has the valve seat surface 31s and internal flow paths L1 and L2 opened to the valve seat surface 31s. The orifice 31 is accommodated in the housing recess 21 such that the valve seat surface 31s faces toward an opening of the housing recess 21. A seal member 34 is provided between a lower surface 31t of the orifice 31 opposite to the valve seat surface 31s and the bottom surface of the housing recess 21 so as to surround an opening of the upstream flow path R1. A flow path communicating with the downstream flow path R2 is formed between an outer peripheral surface 31u of the orifice 31 and the inner peripheral surface of the housing recess 21. Note that details of the orifice 31 will be described later.

The valve body 32 has the seating surface 32s having a planar shape and seated on the valve seat surface 31s. The valve body 32 is movably provided facing the valve seat surface 31s of the orifice 31. The valve body 32 is biased in a valve opening direction (upward) by an elastic member 35 provided on a support member 332c to be described later.

The drive unit 33 includes an actuator 331 and a plunger mechanism 332 that is displaced by the actuator 331 to drive the valve body 32. The plunger mechanism 332 according to the present embodiment uses a plunger 332a that is displaced by extension of the actuator 331 and a diaphragm 332b that supports the plunger 332a in a displaceable manner. The diaphragm 332b and the support member 332c integrally formed on an outer periphery of the diaphragm 332b close the opening of the housing recess 21 with the seal member 36 interposed therebetween. The valve body 32 is accommodated in a space formed between the diaphragm 332b, the support member 332c, and the orifice 31.

Then, when a predetermined voltage is applied to the actuator 331, the actuator 331 extends, and the plunger 332a of the plunger mechanism 332 presses the valve body 32 in a valve closing direction to obtain a valve opening degree corresponding to the applied voltage. On the other hand, in a state where no voltage is applied to the actuator 331, the valve body 32 is fully opened by an elastic force of the elastic member 35.

The flow rate sensor 4 is of a pressure type, and includes a laminar flow element 41 provided in the flow path R, a first pressure sensor 42 provided so as to be able to measure a pressure on an upstream side of the laminar flow element 41, a second pressure sensor 43 provided so as to be able to measure a pressure on a downstream side of the laminar flow element 41, and a flow rate calculator 44 that calculates a flow rate of a fluid flowing through the flow path R on the basis of a first pressure and a second pressure measured by the first pressure sensor 42 and the second pressure sensor 43, respectively. The flow rate sensor 4 is provided on upstream or downstream of the fluid control valve 3 in the flow path R. As a fluid resistance, a sonic nozzle or the like may be used instead of the laminar flow element 41.

The valve controller 5 controls the fluid control valve 3 on the basis of a measured flow rate measured by the flow rate sensor 4. The valve controller 5 is a computer including a CPU, a memory, an A/D converter, a D/A converter, and various input/output units, and controls the fluid control valve 3 by executing a fluid control program stored in the memory and cooperating with the CPU and peripheral devices.

The valve controller 5 controls the opening degree of the fluid control valve 3 on the basis of a command flow rate input from the outside and the measured flow rate measured by the flow rate sensor 4. Specifically, the valve controller 5 controls the opening degree of the fluid control valve 3 so as to reduce a deviation between the command flow rate and the measured flow rate. The valve controller 5 according to the present embodiment performs PID calculation on the deviation between the command flow rate and the measured flow rate, and outputs a command voltage corresponding to the result to a drive circuit of the drive unit 33. The drive circuit applies a voltage corresponding to the input command voltage to a piezo stack 331.

### <Specific Configuration of Orifice 31>

The orifice 31 according to the present embodiment has a configuration for increasing the flow rate and reducing seat leakage in a fully closed state.

As illustrated in FIGS. 2 to 7 (b), the orifice 31 has a substantially disk shape, and has the valve seat surface 31s on one surface (upper surface) of the orifice 31. The orifice 31 includes annular grooves M1 and M2 formed in the valve seat surface 31s, and the internal flow paths L1 and L2 communicating with the upstream flow path R1 or the downstream flow path R2 and opened in the annular grooves M1 and M2.

Specifically, as illustrated in FIGS. 2 to 7 (b), the orifice 31 has an upstream internal flow path L1 communicating with the upstream flow path R1 and a downstream internal flow path L2 communicating with the downstream flow path R2. The orifice 31 has an upstream annular groove M1 to which the upstream internal flow path L1 is opened and a downstream annular groove M2 to which the downstream internal flow path L2 is opened.

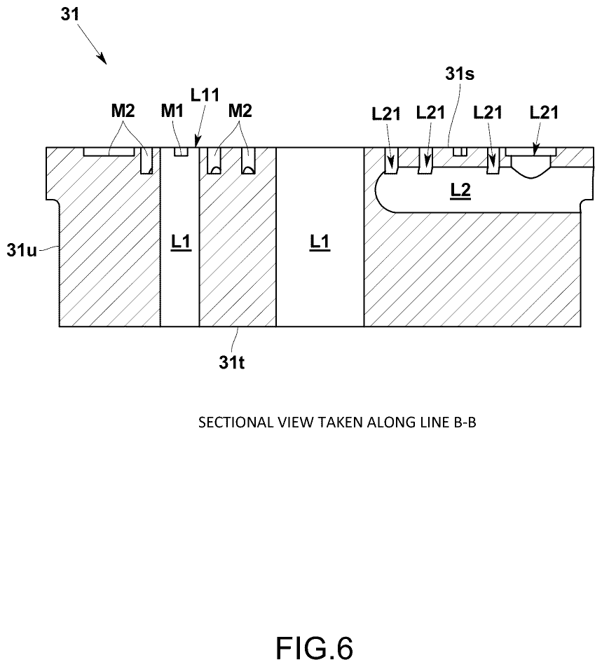

As illustrated in FIG. 6, the upstream internal flow path L1 has a linear shape penetrating through the orifice 31 from the lower surface 31t opposite to the valve seat surface 31s. The upstream internal flow path L1 according to the present embodiment has an equal sectional shape, but is not required to have a flow path shape of an equal sectional shape.

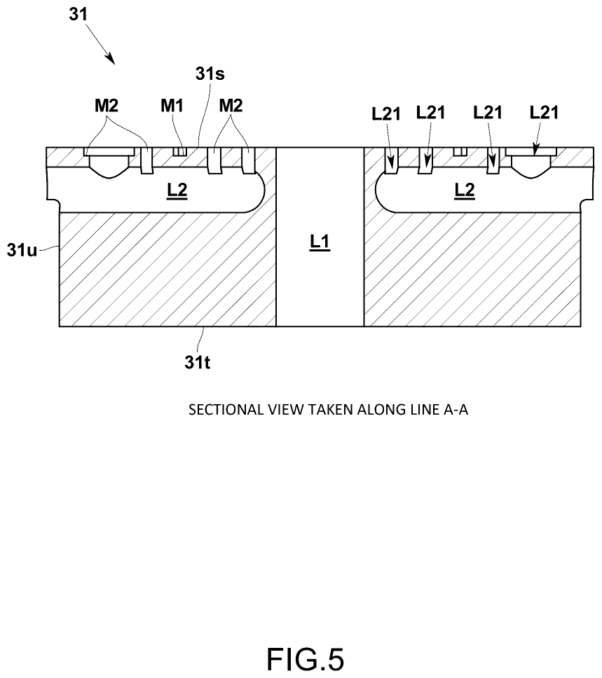

As illustrated in FIGS. 5 and 6, the downstream internal flow path L2 has a linear shape formed radially inward from a side surface (here, the outer peripheral surface 31u) other than the valve seat surface 31s and the lower surface 31t. The downstream internal flow path L2 according to the present embodiment has an equal sectional shape, but is not required to have a flow path shape of an equal sectional shape.

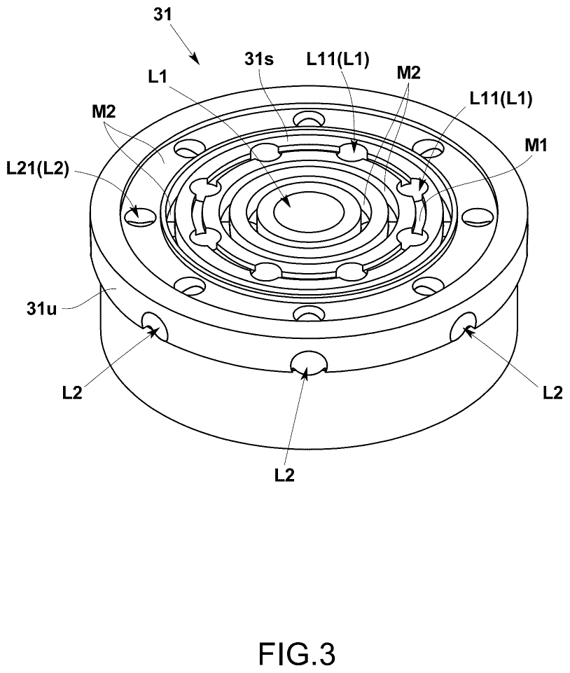

As illustrated in FIGS. 3, 4, and 6, each of the upstream annular groove M1 and the downstream annular groove M2 has an annular shape in plan view. The upstream annular groove M1 according to the present embodiment has a partial annular shape intermittently formed in a circumferential direction, and has an annular shape in plan view together with a virtual annular groove obtained by extending the partial annular shape. Here, each of the upstream annular groove M1 and the downstream annular groove M2 has a groove shape having the same width in the circumferential direction. The upstream annular groove M1 and the downstream annular groove M2 are formed substantially concentrically in the valve seat surface 31s. Furthermore, the upstream annular groove M1 and the downstream annular groove M2 are alternately formed in the valve seat surface 31s. In the present embodiment, two downstream annular grooves M2, one upstream annular groove M1, and two downstream annular grooves M2 are formed in that order from a radially inner side. The annular grooves may have other annular shapes than the annular shape in plan view, such as an elliptical annular shape and a rectangular annular shape.

The upstream annular groove M1 and the downstream annular groove M2 may be alternately formed one by one from the radially inner side.

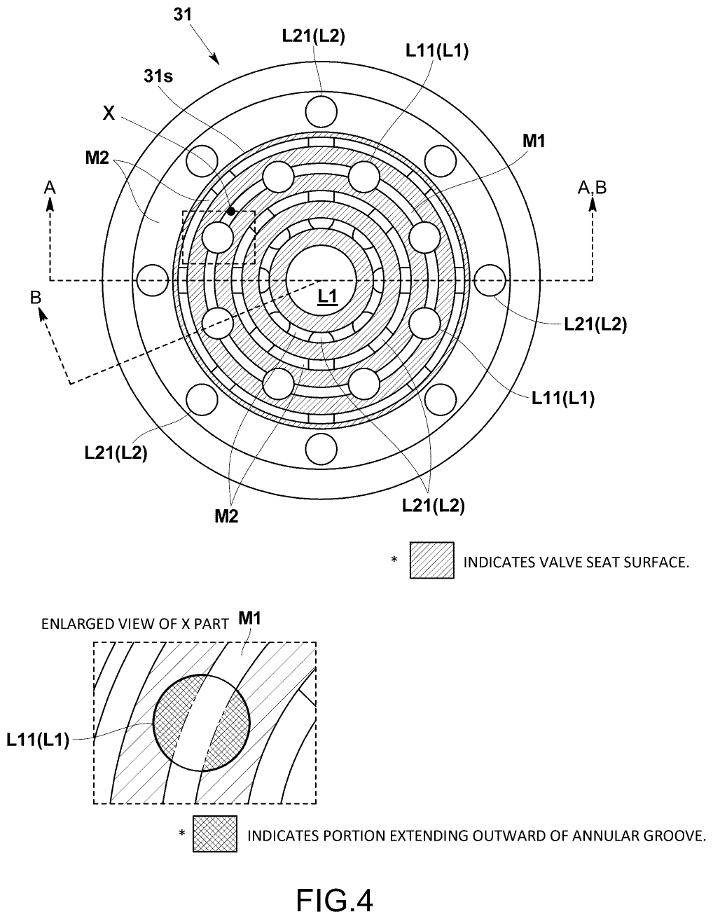

As illustrated in FIGS. 3 and 5 to 7 (b), the upstream internal flow path L1 is opened on the same plane as the valve seat surface 31s, and an opening of the upstream internal flow path L1 extends outward of the upstream annular groove M1 in plan view as illustrated in FIG. 4. That is, an opening edge of an opening L11 of the upstream internal flow path L1 protrudes outward from the virtual annular groove in the upstream annular groove M1 in plan view. Specifically, the opening L11 of the upstream internal flow path L1 has a circular shape in plan view of the valve seat surface 31s, and has an opening diameter formed to be larger than a groove width along a radial direction of the upstream annular groove M1. That is, the opening L11 of the upstream internal flow path L1 protrudes radially outward from an outer side surface of the upstream annular groove M1, and protrudes radially inward from an inner side surface of the upstream annular groove M1. In addition, the upstream internal flow path L1 is also opened in a central portion of the valve seat surface 31s surrounded by the downstream annular groove M2 on an innermost side.

As illustrated in FIG. 4, the valve seat surface 31s between the upstream annular groove M1 and the downstream annular groove M2 adjacent to the outside has a substantially annular shape in plan view, but has a shape in which a part of an inner periphery is cut out in a partial arc shape by the opening L11 of the upstream internal flow path L1. The valve seat surface 31s between the upstream annular groove M1 and the downstream annular groove M2 adjacent to the inside has a substantially annular shape in plan view, but has a shape in which a part of an outer periphery is cut out in a partial arc shape by the opening L11 of the upstream internal flow path L1.

On the other hand, as illustrated in FIGS. 3 and 5 to 7 (b), the downstream internal flow path L2 opens on a bottom surface of the downstream annular groove M2. Specifically, an opening L21 of the downstream internal flow path L2 is formed to have a groove width equal to or smaller than a groove width along a radial direction of the downstream annular groove M2. That is, the opening L21 of the downstream internal flow path L2 is formed between an outer side surface and an inner side surface of the downstream annular groove M2.

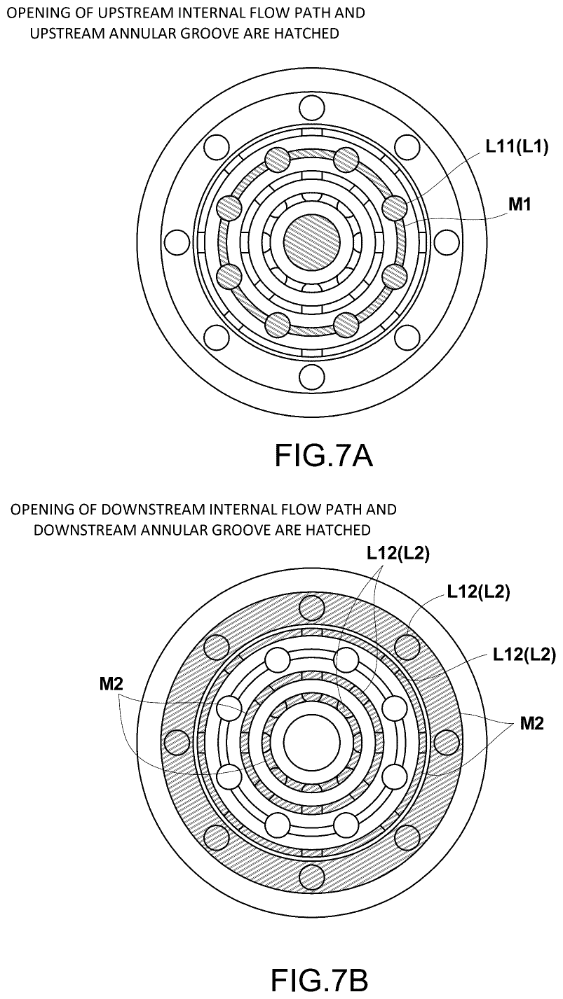

As illustrated in FIGS. 4 and 7 (b), the opening L11 of the upstream internal flow path L1 communicating with the upstream annular groove M1 and the opening L21 of the downstream internal flow path L2 communicating with the downstream annular groove M2 are formed to be shifted from each other in the circumferential direction in plan view.

A plurality of upstream internal flow paths L1 communicates with the upstream annular groove M1. In the present embodiment, one upstream internal flow path L1 communicates with the upstream annular groove M1 through the virtual annular groove in the upstream annular groove M1. The upstream annular groove M1 has a recessed shape having a bottom surface formed at a position different from the opening L11 illustrated in FIG. 6 and shallower than the downstream annular groove M2. The plurality of upstream internal flow paths L1 communicating with the upstream annular groove M1 are formed at equal intervals in the circumferential direction in the upstream annular groove M1. When each upstream internal flow path L1 is viewed, a circumferential end of the upstream annular groove M1 is opened on an inner peripheral surface facing the valve seat surface 31s forming the upstream internal flow path L1. Two upstream internal flow paths L1 adjacent to each other in the circumferential direction are connected by one upstream annular groove M1.

A plurality of downstream internal flow paths L2 communicates with the downstream annular groove M2. In the present embodiment, one downstream internal flow path L2 communicates with a plurality of downstream annular grooves M2. The plurality of downstream internal flow paths L2 communicating with the downstream annular groove M2 are radially formed at equal intervals in the circumferential direction in the downstream annular groove M2.

Here, as illustrated in FIGS. 5 and 6, the upstream annular groove M1 and the downstream annular groove M2 are formed from the valve seat surface 31s toward the lower surface 31t, and have different depths. In the present embodiment, the downstream annular groove M2 is configured to be deeper than the upstream annular groove M1. The upstream annular groove M1, which is a shallower annular groove, is connected to the upstream internal flow path L1 penetrating from the lower surface 31t opposite to the valve seat surface 31s. The downstream annular groove M2, which is a deep annular groove, is connected to the linear downstream internal flow path L2 formed from a side surface (here, the outer peripheral surface 31u) other than the valve seat surface 31s and the lower surface 31t.

In the present embodiment, the downstream annular groove M2 and the linear downstream internal flow path L2 intersect each other, and the linear downstream internal flow path L2 is directly connected to the downstream annular groove M2. The downstream internal flow path L2 is in a skew position with the upstream internal flow path L1 and in a skew position with the upstream annular groove M1.

### <Simulation Results>

Next, as for the maximum flow rate for flowing in the fully opened state of the fluid control valve and a seat leakage amount in the fully closed state, comparison results between the amounts with use of the orifice 31 according to the present embodiment (present example) and the amounts with use of a conventional orifice (conventional example) will be described.

The conventional orifice has a configuration in which the upstream internal flow path is opened to the bottom surface of the upstream annular groove and the downstream internal flow path opens to the bottom surface of the downstream annular groove. In the fluid control valve, configurations other than the orifice are common in the present embodiment and in the conventional example.

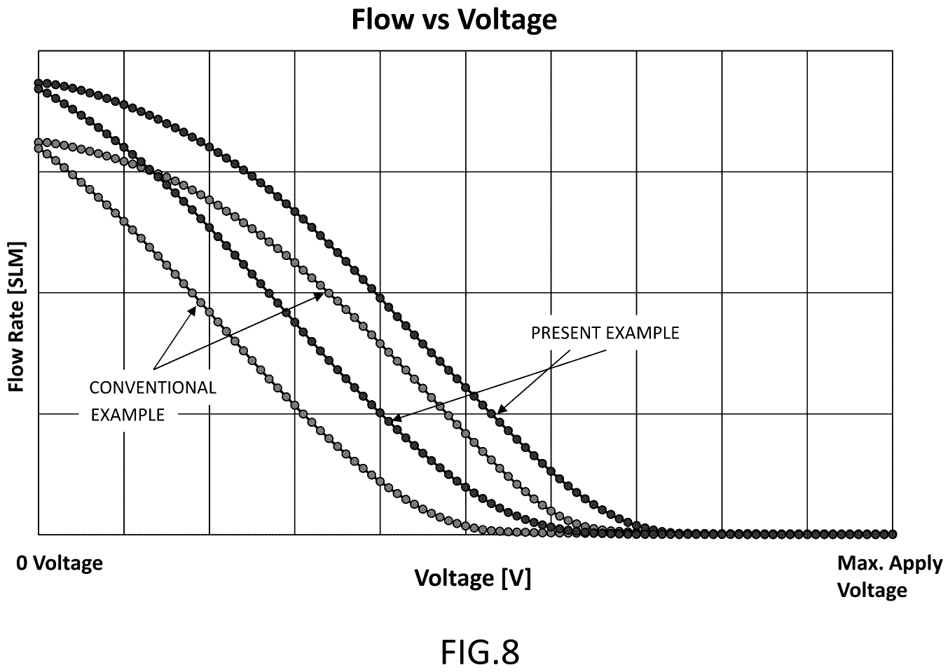

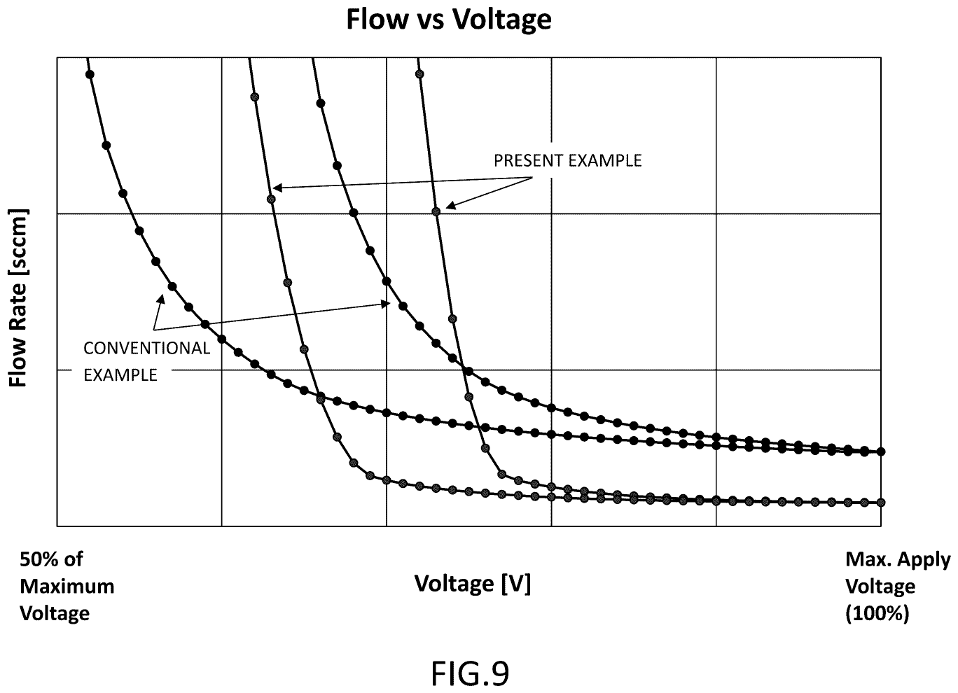

As illustrated in FIG. 8, the maximum flow rate for flowing in the fully opened state is larger in the present embodiment than in the conventional example. As illustrated in FIG. 9, for example, from 70% or more of a maximum value (100%) of a drive voltage to the fully closed state with the maximum value (100%) of the drive voltage, the seat leakage amount is smaller in the present example than in the conventional example.

### Effects of Embodiment

In the fluid control device 100 configured as described above, the upstream internal flow path L1 is opened on the same plane as the valve seat surface 31s, and the opening L11 extends outward of the upstream annular groove M1 in plan view. It is therefore possible to reduce seat leakage while improving the maximum flow rate. Specifically, in the configuration in which the upstream internal flow path L1 is opened to the bottom surface of the upstream annular groove M1, the size of the opening L11 is limited to the groove width of the upstream annular groove M1, but in the present embodiment, the size of the opening of the upstream internal flow path L1 is not limited to the groove width of the upstream annular groove M1. As a result, the maximum flow rate can be improved. The groove width of the upstream annular groove M1 can be narrowed regardless of the size of the opening of the upstream internal flow path L1. As a result, the area of the valve seat surface 31s can be increased, and seat leakage can be reduced. Furthermore, by increasing the area of the valve seat surface 31s, a stress generated between the valve seat surface 31s and the seating surface 32s in the fully closed state can be reduced, and damage of the seating surface 32s or the valve seat surface 31s can be reduced.

### OTHER EMBODIMENTS

For example, the opening L21 of the downstream internal flow path L2 may extend outward of the downstream annular groove M2 in plan view, similarly to the opening L11 of the upstream internal flow path L1 according to the embodiment. In this case, the downstream internal flow path L2 opens on the same plane as the valve seat surface 31s, and the opening L21 extends outward of the downstream annular groove M2 in plan view.

The openings L11 and L21 of the internal flow paths L1 and L2 may extend outward of the corresponding annular grooves M1 and M2 in plan view.

Furthermore, the downstream internal flow path L2 is not required to be linearly formed and directly connected to the downstream annular groove M2, and the downstream internal flow path L2 may include a longitudinal flow path opened to the bottom surface of the downstream annular groove M2 and a lateral flow path connected to the longitudinal flow path and opened to the outer peripheral surface of the orifice 31.

The valve seat surface 31s according to the embodiment is provided with one upstream annular groove M1 and two downstream annular grooves M2, but may be provided with two upstream annular grooves M1 and one downstream annular groove M2, or may be provided with a plurality of upstream annular grooves M1 and a plurality of downstream annular grooves M2.

The fluid control valve 3 may be a solenoid valve or a valve using an actuator, other than a piezo valve.

The flow rate measurement unit according to the embodiment is of a pressure type, but may be of a thermal type.

In addition, various modifications or combinations of the embodiments may be made without departing from the gist of the present invention.

### REFERENCE CHARACTER LIST

100 fluid control device
R1 upstream flow path
R2 downstream flow path
3 fluid control valve
31 orifice
31s valve seat surface
31t lower surface
31u outer peripheral surface
L1 upstream internal flow path
L11 opening of upstream internal flow path
L2 downstream internal flow path
L21 opening of downstream internal flow path
M1 upstream annular groove
M2 downstream annular groove
32 valve body
32s seating surface
4 flow rate measurement unit
5 valve controller

1. A fluid control valve that controls a fluid from an upstream flow path to flow out to a downstream flow path, the fluid control valve comprising:
an orifice having a valve seat surface; and
a valve body having a seating surface seated on the valve seat surface,
wherein the orifice includes
an annular groove formed in the valve seat surface, and
an internal flow path communicating with the upstream flow path or the downstream flow path and opened in the annular groove,
the internal flow path is opened on a same plane as the valve seat surface, and an opening of the internal flow path extends outward of the annular groove in a plan view.

2. The fluid control valve according to claim 1, wherein
the internal flow path includes
an upstream internal flow path communicating with the upstream flow path, and
a downstream internal flow path communicating with the downstream flow path, the annular groove includes
an upstream annular groove to which the upstream internal flow path is opened, and
a downstream annular groove to which the downstream internal flow path is opened, and
the upstream internal flow path opens on the same plane as the valve seat surface, and an opening of the upstream internal flow path extends outward of the upstream annular groove in a plan view, or the downstream internal flow path opens on the same plane as the valve seat surface, and an opening of the downstream internal flow path extends outward of the downstream annular groove in a plan view.

3. The fluid control valve according to claim 2, wherein the upstream annular groove and the downstream annular groove are formed substantially concentrically in the valve seat surface.

4. The fluid control valve according to claim 2, wherein the upstream annular groove and the downstream annular groove are formed alternately in the valve seat surface.

5. The fluid control valve according to claim 2, wherein
a plurality of the upstream internal flow paths is opened in the upstream annular groove, and
a plurality of the downstream internal flow paths is opened in the downstream annular groove.

6. The fluid control valve according to claim 5, wherein openings of the upstream internal flow paths and openings of the downstream internal flow paths are formed to be shifted from each other in a circumferential direction in the plan view.

7. The fluid control valve according to claim 2, wherein the upstream annular groove and the downstream annular groove have different depths from each other.

8. The fluid control valve according to claim 7, wherein an internal flow path penetrating from a lower surface opposite to the valve seat surface communicates with a shallower annular groove of the upstream annular groove or the downstream annular groove.

9. The fluid control valve according to claim 7, wherein a linear internal flow path formed from a side surface other than the valve seat surface and a lower surface opposite to the valve seat surface communicates with a deeper annular groove of the upstream annular groove or the downstream annular groove.

10. A fluid control device comprising:
the fluid control valve according to claim 1;
a flow rate measurement unit that measures a flow rate of a flow path; and
a valve controller that controls the fluid control valve on a basis of a measurement value measured by the flow rate measurement unit.
